(19) United States
(12) Patent Application Publication
(10) Pub. No.: US 2006/0205846 A1
(43) Pub. Date: Sep. 14, 2006

(54) Method of providing color variation in an extruded product

(75) Inventors: Joseph J. Spitz, Baraboo, WI (US); Bradley Felton, Middleton, WI (US)

Correspondence Address: FOLEY & LARDNER LLP, 150 EAST GILMAN STREET, P.O. BOX 1497, MADISON, WI, 53701-1497, US

(73) Assignee: Teel Plastics, Inc.

(21) Appl. No.: 11/358,646

(22) Filed: Feb. 21, 2006

Related U.S. Application Data
(60) Provisional application No. 60/654,987, filed on Feb. 22, 2005.
(60) Provisional application No. 60/672,181, filed on Apr. 15, 2005.

(51) Int. Cl. C08K 11/00

(52) U.S. Cl. 524/9; 524/13

(57) ABSTRACT

A process is provided for forming a building product having a color variation representative of a “natural” building material. The process includes feeding a first amount of a first material and a second amount of a second material to an extruder, mixing at least a portion of the first amount with at least a portion of the second amount in the extruder to form a third material, and extruding the third material from the extruder to form a product from the extruded third material. The formed product has a color variation representative of a “natural” building material such as ceramic, clay, wood, slate, stone, brick, concrete, metal, etc. The first material is formed of a first fiber, a first resin, and a first colorant. The second material is formed of a second fiber, a second resin, and a second colorant, wherein the second colorant is different than the first colorant.

### CLAIM OF PRIORITY

This application claims priority from U.S. Provisional Patent Application No. 60/654,987, filed Feb. 22, 2005, and from U.S. Provisional Patent Application No. 60/672,181, filed Apr. 15, 2005.

### FIELD OF THE INVENTION

The subject of the disclosure relates generally to building materials formed of fibers and polymers. More specifically, the disclosure relates to a method for providing color variation in the building materials so that the finished product appears like a natural building material product.

### BACKGROUND OF THE INVENTION

A number of different building products have been developed and used over the years to cover a building both on the exterior and in the interior of the building. Additional building products not associated with the building itself include fencing and decking products. Various factors may be considered in choosing a building product including the cost of the product, the ease of application or installation of the product, and the appearance of the product. With respect to those products that are exterior to the building, such as roofing, siding, decking, fencing, etc., the performance or weatherability of the product is at least as important as the other factors. For example, the ability of the building product to withstand cold, rain, hail, and wind, to shed snow, and to withstand ice buildup without significant damage. Fire resistance is another important consideration and is increasingly being identified by insurance companies as a desirable attribute for lowering insurance premiums. Interior materials such as flooring also need to withstand spills, heavy foot traffic, dropped objects, etc.

Building materials for both the interior and the exterior of a building include wood, clay, concrete, slate, stone, brick, metal, ceramic, etc. These “natural materials” provide a distinctive and aesthetically pleasing appearance that is acceptable in even the most expensive neighborhoods. These materials generally withstand wide ranging temperatures, rain, snow, and wind, and provide some fire resistance. However, these materials can be expensive, may be susceptible to damage from hail or dropped objects, and their installment is generally labor intensive. The need to replace “natural materials” has led to the development of products that include a variety of synthetic materials such as asbestos, fiberglass, and asphalt. However, the products developed using these materials do not provide the sought after appearance of the “natural materials.” Additionally, these synthetic materials have useful lifetimes which are generally shorter than the structure which they are designed to protect and to cover and are made of environmentally unfriendly materials that are not amenable to disposal or recycling.

U.S. Pat. No. 6,983,571, hereby incorporated in its entirety by reference, discloses a construction panel that is a mixture of fibers and a polymeric material. The construction panel is inexpensive, easy to construct, simple to install, and readily moldable to have varying exterior surface patterns. As a result, the construction panels can be formed in the shape of products made of “natural materials.” There remains, however, a need for a rugged, durable building product that has a color variation that is representative of the “natural material” that it replaces.

Attempts to create a realistic natural color variation have been made previously. For example, “streaker pellets” sprinkled into the continuous feed hopper of an extruder have been utilized. The pellets are formulated to contain individual colors and to have melt points that differ from the bulk polymer and sometimes from each other. In the extruder, the pellets soften, but have a very high viscosity, and thus, are momentarily trapped on surfaces, breaker plates, or screens in the polymer flow stream. As a result, the colors “bleed” (deform and erode) in the die profile giving various random color streak appearances. Such prior art processes have not demonstrated realistic color variation, however. Additionally, typical prior art processes provide only surface coloring effects because the process is too expensive to incorporate the coloring in the bulk of the article. As a result, color variation varies as the article is exposed to wear and to other elements.

### SUMMARY OF THE INVENTION

An exemplary embodiment of the invention provides a process for forming a composite product having a color variation representative of a “natural” building material. The process includes, but is not limited to, feeding a first amount of a first material and a second amount of a second material to an extruder, mixing at least a portion of the first amount with at least a portion of the second amount in the extruder to form a third material, and extruding the third material from the extruder to form a product from the extruded third material. The formed product has a color variation representative of a natural building material. The first material is formed of a first fiber, a first resin, and a first colorant. The second material is formed of a second fiber, a second resin, and a second colorant, wherein the second colorant is different than the first colorant. The color variation may be applied throughout the formed product.

Additional materials having the same or a different colorant may be added in the same or a different amount to form the third material. The colorants and/or amounts of material may be selected based on a color analysis of the natural building material. The amounts of material may be selected using a random number selected using a statistical distribution. The second amount of the second material, in general, is fed to the extruder substantially after the first amount of the first material is fed to the extruder. The formed product may be formed from the extruded third material using any of a linear extrusion process, a compression molding process, an extrusion molding process, an injection molding process, extruding the third material through a die, coating the third material on a substrate, etc.

The formed product may be used on the interior or the exterior of a structure and/or as fencing or decking material. Exemplary products include roofing tiles, shingles, and shakes, flooring tiles and boards, siding, paneling, decking posts, boards, and rails, fence posts, boards, rails, etc that have the appearance of being made of ceramic, clay, wood, slate, stone, brick, concrete, metal, and combinations thereof.

Other principal features and advantages of the invention will become apparent to those skilled in the art upon review of the following drawings, the detailed description, and the appended claims.

### BRIEF DESCRIPTION OF THE DRAWINGS

Exemplary embodiments of the invention will hereafter be described with reference to the accompanying drawings, wherein like numerals will denote like elements.

FIG. 1 is a schematic diagram of a product forming process that includes an extrusion process in accordance with an exemplary embodiment.

FIG. 2 is a flow diagram illustrating exemplary operations of the product forming process of FIG. 1 in accordance with an exemplary embodiment.

FIG. 3 is a cross sectional view of a twin screw extruder in accordance with an exemplary embodiment.

FIG. 4 is a schematic diagram of an extrusion process in combination with a compression molding process in accordance with an exemplary embodiment.

FIG. 5 shows an exemplary roofing shingle formed using the process of FIG. 4.

### DETAILED DESCRIPTION OF THE EXEMPLARY EMBODIMENTS

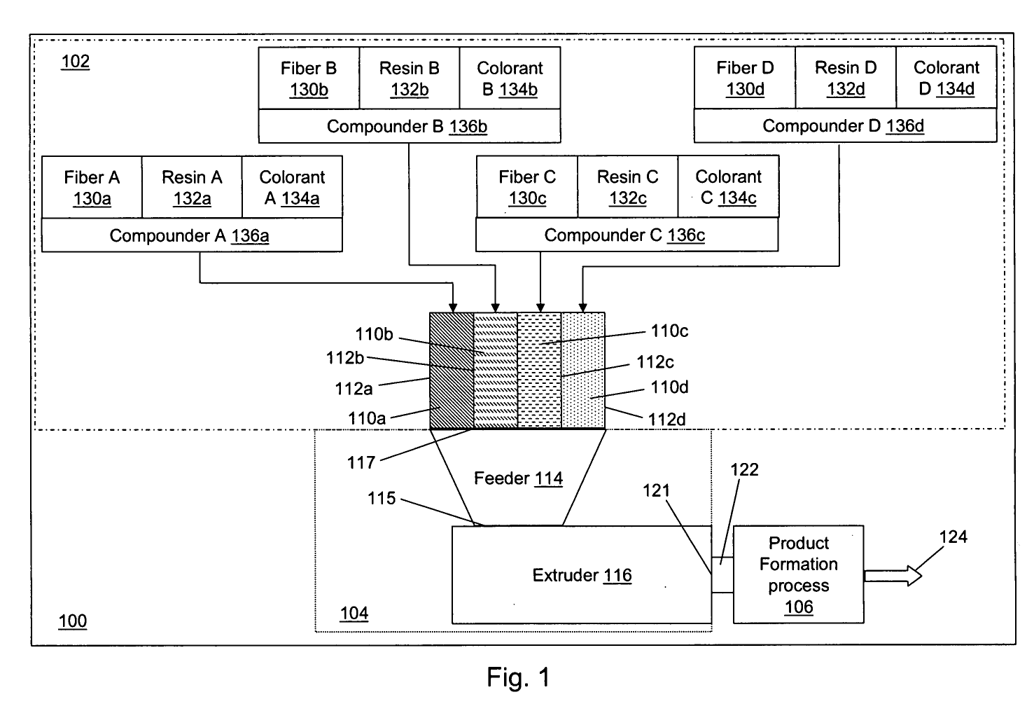

With reference to FIG. 1, a diagram of a process 100 in accordance with an exemplary embodiment is shown. Process 100 may include a material provision process 102, an extrusion process 104, and a product formation process 106. Material provision process 102 provides a plurality of materials 110a, 110b, 110c, 110d to extrusion process 104. Extrusion process 104 includes a feeder 114 and an extruder 116. Extrusion process 104 provides an extruded material 122 to product formation process 106, which forms a product 124. Formed product 124 may be any of a roofing tile, a roofing shingle, a roofing shake, a flooring tile, a flooring board, a siding board, a paneling board, a decking post, a decking board, a decking rail, a fence post, a fence board, a fence rail, etc. Formed product 124 has a color variation representative of a natural building material such as ceramic, clay, wood, slate, stone, brick, concrete, metal, and combinations thereof. Product formation process 106 may include any of a linear extrusion process extruding the third material through a die, a compression molding process, an injection molding process, coating the third material on a substrate, etc.

A material 110 is formed of a fiber 130, a resin 132, and a colorant 134. For example, fiber 130 includes plant fibers, such as barley, wheat straw, rice straw, rice hulls, soy stalks, stalks of perennial grasses, stalks of annual grasses, sugar cane bagasse, kenaf, sawdust, wood, wood flour, hemp, coconut coir, jute, sisal, flax, coir pith, cotton, other forest product residue, and mixtures thereof. Any suitable fiber can be used. Resin 132 may be polyolefin or other thermoplastic polymers, or combinations thereof. Polyolefins include high density polyethylene, medium density polyethylene, low density polyethylene, polypropylene, ethylene vinyl acetate copolymers. Other thermoplastics include polystyrene, polyisobutylene, acrylonitrile butadiene styrene, polyesters, polyethylene terephthalate, polyvinyl chloride, polyamides, and mixtures thereof. Resin 132 may be made of a pure polymer or a blend of any of a number of different polymers. Preferably, a high proportion of the polymer is obtained from recycled sources. Any suitable resin can be used. Colorant 134 may be any organic or inorganic pigments and dye known to those of skill in the art both now and in the future. Inorganic metal oxides such as Fe₂O₃, Fe₃O₄, MₙFe₂O₄, ZₙFe₂O₄, and TiO₂, etc. may be used as colorant 134 in an exemplary embodiment. Other colorants may be used as known to those skilled in the art.

In an exemplary embodiment for use in a roofing material, material 110 is compounded using: between about 40% and 75% natural plant fibers; between about 20% and 60% resin; up to about 1% UV stabilizer; up to about 6% colorant; up to about 5% fungicide; up to 0.5% antioxidant; up to about 20% flame retardant; up to about 10% inorganic filler, which can take the place of natural fibers to reduce the heat of combustion of the composition, and thus, improve fire resistance; and up to about 3% coupling agent. The components are mixed or compounded together using compounder 136 to form material 110. Preferably, material 110 is a homogenous mixture that provides consistent quality and characteristics in the formation of extruded material 122. Material 110 may be compounded by any mixing means known in the art now or in the future. Material 110 can be produced from many varying synthetic compositions as known to those of skill in the art.

With reference to FIG. 1, material 110a is formed from a fiber A 130a, a resin A 132a, a colorant A 134a, and other components such as a UV stabilizer, a fungicide, etc. as discussed above. Fiber A 130a, resin A 132a, and colorant A 134a are mixed together using compounder A 136a to form material 110a. Material 110b is formed from a fiber B 130b, a resin B 132b, a colorant B 134b, and other components such-as a UV stabilizer, a fungicide, etc. Fiber B 130b, resin B 132b, and colorant B 134b are mixed together using compounder B 136b to form material 110b. Material 110c is formed from a fiber C 130c, a resin C 132c, a colorant C 134c, and other components such as a UV stabilizer, a fungicide, etc. Fiber C 130c, resin C 132c, and colorant C 134c are mixed together using compounder C 136c to form material 110c. Material 110d is formed from a fiber D 130d, a resin D 132d, a colorant D 134d, and other components such as a UV stabilizer, a fungicide, etc. Fiber D 130d, resin D 132d, and colorant D 134d are mixed together using compounder D 136d to form material 110d.

As known to those skilled in the art, the materials 110 can be mixed or melted and mixed at a temperature and with a shear energy sufficient to cause mixing and wetting of the ingredients and the removal of moisture from the fiber while mixing is accomplished. The material 110 may be dried in a desiccant dryer to exhibit a desired moisture content. As a result, compounding of the materials 110 is used in an exemplary embodiment so that the materials are melted and mixed so that they become a homogenous, continuous material 110. The fiber 130, resin 132, and/or colorant 134 may be the same or different among the materials 110 used. For example, the fiber 130 may be changed in type or in size to provide an additional difference in appearance such as a wood flour particle size difference or flax in one of the materials to provide different texturing.

In an exemplary embodiment, materials 110a, 110b, 110c, 110d are supplied to feeder 114 in bins 112a, 112b, 112c, 112d, respectively. Any number of materials 110 can be supplied to feeder 114 using various mechanisms. The use of four materials is not intended to limit the invention in any way. The formation of product 124 utilizes at least two materials 110, though any number of materials in varying amounts and sequence of addition to extruder 116 may be used.

With reference to FIG. 1, materials 110a, 110b, 110c, 110d are placed in bins arranged at feeder 114 and automatically supplied to feeder 114 through an intake 117 of feeder 114. For example, a controller may automatically open each bin 112a, 112b, 112c, 112d to intake 117 at the appropriate time and/or automatically close each bin 112a, 112b, 112c, 112d to intake 117 to supply the desired amount of each material 110a, 110b, 110c, 110d to intake 117. In an alternative embodiment, materials 110a, 110b, 110c, 110d are manually supplied to feeder 114 through intake 117. Manual supply may entail manually selecting one of bins 112a, 112b, 112c, 112d to open to intake 117 or may entail manually scooping the desired amount of each material 110a, 110b, 110c, 110d into intake 117 at the appropriate time. Various mechanisms for supplying materials 110a, 110b, 110c, 110d to feeder 114 are known to those skilled in the art both now and in the future. For example, feeder 114 may be a gravimetric feeder. Feeder 114 may measure the amount of material 110 fed through throat 115 and into extruder 116, thereby metering the batch size to allow specific amounts of material to be used in the process. In general, it is more difficult to achieve the desired coloring if the materials 110 are added to the feeder 114 in a dry non-compounded form because too much mixing may be required in extruder 116 resulting in inadequate color variation.

In an exemplary embodiment, feeder 114 feeds materials 110a, 110b, 110c, 110d to extruder 116 through a throat 115. Feeding of the materials 110a, 110b, 110c, 110d through throat 115 results in an unsteady state flow of the materials to extruder 116. Extruder 116 melts materials 110a, 110b, 110c, 110d to form extruded material 122. Extruders for a myriad of plastic-containing feed materials are well known to those of ordinary skill in the art. It is not an object of the present invention that the extruder so described herein limit in any way the ability of this invention to cover the many extruders known in the art both now and in the future. In an exemplary embodiment, extruder 116 includes a screw mechanism such as a Galilean screw or other screw mechanism that melts and conveys materials 110a, 110b, 110c, 110d toward an adapter 121. The extruded material exits the extruder through adapter 121 that gives the exiting, extruded material a cross-sectional shape that may be one of many shapes. For example, the cross-sectional shape may be approximately round, pipe-shaped, square, ovular, rectangular, triangular, ribbon-like, or any shape that an adapter may form as is known to those of skill in the art. In an alternative embodiment, adapter 121 may be a die mounted to extruder 116 to provide the texture and shape of product 124. Alternatively, extruded material may exit adapter 121 and enter a die that provides the texture and shape of product 124. In still another alternative embodiment, as the extruded material exits the extruder in a given cross-sectional shape, the extruded material may be placed in a mold. The mold may impart the texture and shape of product 124 using a variety of molding processes such as compression molding, injection molding, etc.

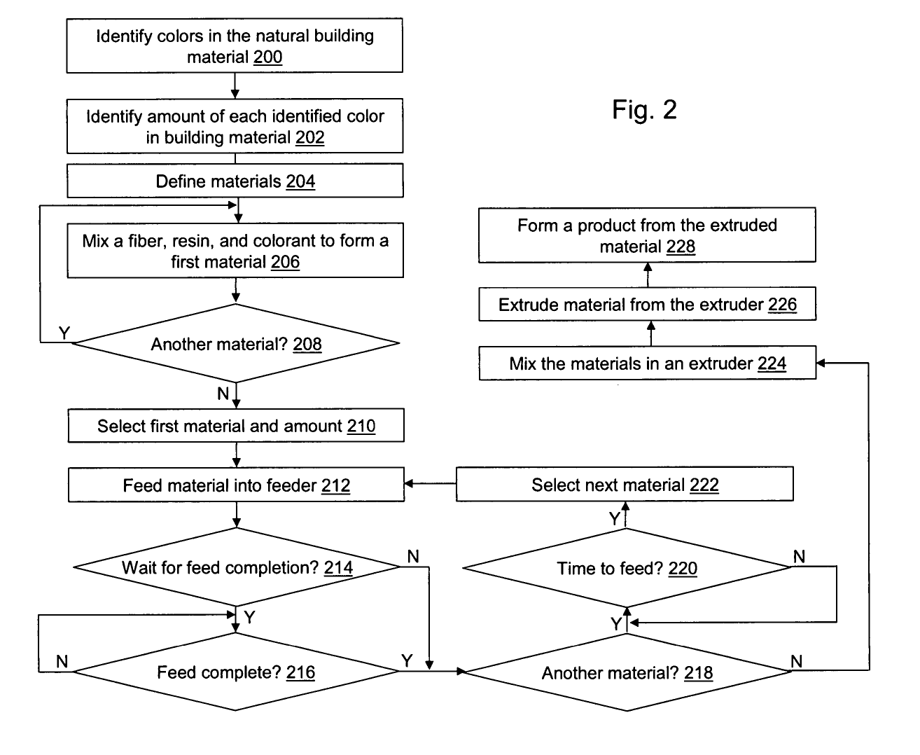

With reference to FIG. 2, exemplary operations of process 100 are shown. Additional, fewer, or different operations may be performed, depending on the embodiment without deviating from the spirit of the invention. In an operation 200, colors are identified in the natural building material. In an operation 202, the amount of each identified color in the natural building material is identified. For example, a color analysis of the natural building material is performed. In an exemplary embodiment, the building material may be a cedar shake. Cedar has a different color variation depending on the age and style of the building product and its exposure to weather elements. For example, cedar variation can be denoted as a first cedar, a second cedar, and a third cedar with each type exhibiting a different color variation. In an operation 204, the materials for forming the product based on analysis of the natural building material are defined. The material and amount for each identified color is defined as well as the sequence for adding the colors to feeder 114.

In a first exemplary embodiment, to form a shingle having the first cedar color variation, materials 110a, 110b, 110c, 110d are defined for four different colors. Material 110a in the amount of 4.75 pounds is added to feeder 114 first. Material 110b in the amount of 4.75 pounds is added to feeder 114 second. Material 110d in the amount of 1.2 pounds is added to feeder 114 third. Material 110a in the amount of 4.75 pounds is added to feeder 114 fourth. Material 110c in the amount of 4.75 pounds is added to feeder 114 fifth. Material 110d in the amount of 1.2 pounds is added to feeder 114 sixth. The amount added may be measured by time, volume, weight, by percentage of total time, volume, weight, by turns of the screw within extruder 116, or by other methods of measurement known to those of skill in the art.

As another example, to form a product having the second cedar color variation, 14.25 pounds of material 110a may be added to feeder 114 followed by 4.75 pounds of material 110d. In an exemplary embodiment, colorant A 134a of material 110a may be a mixture of 48% yellow, 18% white, 28% black, and 6% red by weight. Colorant D 134d of material 110d may be a mixture of 74% yellow, 12% white, 4% black, and 10% red by weight. Sequential feeding of materials 110a and 110d having these colorants results in the second cedar color variation.

As another example, to form a product having the third cedar color variation, a sequence of materials 110a, 110b, and 110c may be used in the sequence/amount in pounds: material 110c/2.4, material 110b/1.2, material 110c/2.4, material 110b/1.2, material 110c/2.4, material 110b/1.2, and material 110a/1.2.

In an operation 206, a fiber, a resin, a colorant, etc. are mixed to form a first material such as material 110a. An operation 208 determines if another material is included in product 124. If so, processing continues at operation 206 with the next material. If not, processing continues at operation 210. In operation 210, the first material in the sequence of materials is selected and its amount. The amount of material may be selected using a random number selected using a statistical distribution. For example, color analysis may indicate variation in the amount of a color. To impart this variation in product 124, the amount of a material selected may be randomly selected from a statistical distribution defined to provide the appropriate statistical variation of the color. In operation 212, the selected material is fed into feeder 114. For example, material 110a in the amount of 4.75 pounds is fed into feeder 114.

Operation 214 determines if the addition of the next material in the sequence should wait for completion of the feed of the current material through intake 117 and/or throat 115. There may be some overlap between successive feed actions at intake 117 and/or throat 115. For example, the feed of material 110b may be initiated before material 110a has been completely fed through intake 117. Alternatively, the feed of material 110b may be initiated before material 110a has been completely fed through throat 115, but after material 110a has been completely fed through intake 117. As still another alternative, the feed of material 110b may be initiated after material 110a has been completely fed through intake 117 and through throat 115. In an exemplary embodiment, material 110a is completely fed into feeder 114 through intake 117, but before material 110a has been completely fed through throat 115.

If the addition of the next material in the sequence should wait for completion of the feed of the current material through intake 117 and/or throat 115, processing continues at operation 216. If the addition of the next material in the sequence should not wait for completion of the feed of the current material through intake 117 and/or throat 115, processing continues at operation 218.

Operation 216 determines if the feed of the current material through intake 117 and/or throat 115 is complete. If the feed of the current material through intake 117 and/or throat 115 is complete, processing continues at operation 218. If the feed of the current material through intake 117 and/or throat 115 is not complete, processing continues at operation 216 to wait for feed completion. Operation 218 determines if another material is to be added to feeder 114. If another material is to be added to feeder 114, processing continues at operation 220. If another material is not to be added to feeder 114, processing continues at operation 224.

Operation 220 determines if it is time to feed the next material into feeder 114. For example, there may be a time delay before the addition of the next material to allow time to feed all or a portion of the current material through intake 117 and/or though throat 115. If it is time to feed the next material into feeder 114, processing continues at operation 222. If it is not time to feed the next material into feeder 114, processing continues at operation 220 to wait for the time to feed the next material through intake 117.

In operation 222, the next material is selected and processing continues at operation 212. As discussed previously, the amount of material may be selected using a random number selected using a statistical distribution. In operation 224, the materials are melted and conveyed in extruder 116. Additionally, the next material selected may be selected based on a random selection among a set of materials. The process of melting and conveying material in extruder 116 occurs simultaneously with the feeding of materials into feeder 114. In operation 226, extruded material 122 is extruded from extruder 116. In operation 228, product 124 is formed in production process 106.

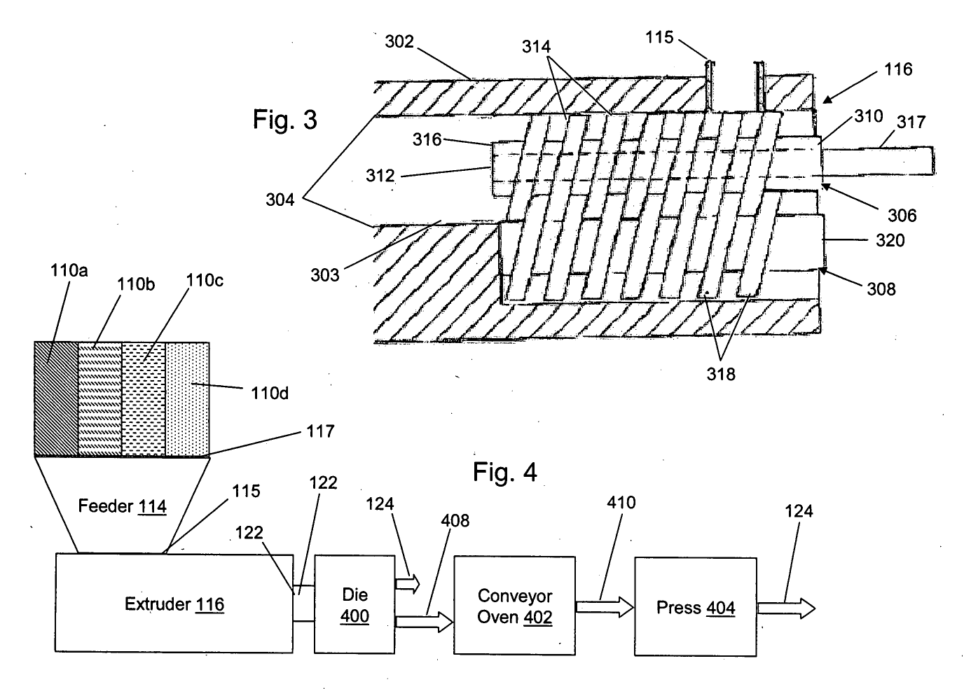

FIG. 3 shows a cross sectional view of an exemplary double screw extruder 116. Exemplary extruder 116 includes throat 115, a barrel 302, an outlet port 304, a first screw 306, and a second screw 308. First screw 306 and second screw 308 are positioned within an internal cavity 303 of barrel 302. Internal cavity 303 is dimensioned to accommodate first screw 306 and second screw 308 as well as the material to be melted and conveyed to produce the desired finished product 124 or intermediate extruded material 122. Outlet port 304 permits removal of processed material and may include adapter 121 and/or die 400 (see FIG. 4).

First screw 306 may include a plurality of threads 314, an exterior shaft 316, and an interior shaft 317 and is mounted within barrel 302 in a longitudinal direction along barrel 302. The plurality of threads 314 extend from exterior shaft 316 and may be slanted either toward or away from outlet port 304 or perpendicular to exterior shaft 316. In general, the plurality of threads 314 are contiguous to cause continuous movement of the material toward outlet port 304. Interior shaft 317 extends within at least a portion of exterior shaft 316 and may act as a plunger to facilitate movement of the material toward outlet port 304. Exterior shaft 316 includes a first end 310 and a second end 312 opposite the first end 310. Of first end 310 and second end 312, second end 312 is positioned closest to outlet port 304 in the longitudinal direction along barrel 302. Second end 312 which moves toward outlet port 304 may include a variety of members of various shapes, sizes, and configurations to control or facilitate movement of the material toward outlet port 304 through movement of exterior shaft 316 and/or interior shaft 317.

Second screw 308 includes a shaft 320 and a plurality of threads 318. The plurality of threads of first screw 306 and second screw 308 preferably are intermeshed along at least a portion of the length of exterior bore 316 to increase the mixing efficiency of extruder 116. The outer dimensions of screws 306, 308 substantially correspond to the inner dimensions of internal cavity 303 in order to provide a close fit of screws 306, 308 within internal cavity 303 while also allowing rotational movement of screws 306, 308.

The materials are fed into extruder 116 by depositing material, which may be in granular or pellet or compounded form, into throat 115. Material also may be deposited into additional inlet ports as known to those skilled in the art. Once material is added to extruder 116, the melting and conveying thereof is effectuated by rotation of first screw 306 and/or second screw 308. First screw 306 and second screw 308 are rotated by turning exterior bore 316 and bore 320, respectively, using a motor. First screw 306 and second screw 308 may be rotated in the same or different directions to advance the material along the length of internal cavity 303 toward outlet port 304. Extruder 116, may or may not provide heat to the material. Advancement of material along the length of internal cavity 303 locally mixes and melts the material to form a plasticizing material of the desired composition and consistency. Once plasticized, the material has a viscosity suitable for additional processing to form product 124 from extruded material 122.

In extrusion process 104, first screw 306 and/or second screw 308 of extruder 116 contain a region of material from a plurality of the materials added. A single screw extruder may be used in alternative embodiments. For example, extruder 116 contains materials 110a, 110b, 110c, 110d added in the sequence of material 110a, material 110b, material 110d, material 110a, material 110c, material 110d. In an exemplary embodiment, the feeding of each of materials 110a, 110b, 110c, 110d into feeder 114 occurs at the completion of the feeding of the prior material through intake 117, but not before the completion of the feeding of the prior material through throat 115. Rotation of first screw 306 and/or second screw 308 and/or gravity cause a blending of the materials. The blending or mixing of the materials depends upon a myriad of controlling factors such as the viscosity of the materials, the movement of the screw, the force of gravity, and other factors that are known to those of skill in the art. The temperature of the extruder is another factor that may be controlled and can impact the mixing or blending of the two materials, the speed of the process, the viscosity of the materials, etc. Additionally, the back pressure of the material caused by up-stream flow restrictions can affect the mixing in the extruder as well.

Material may exit the tip of first screw 306 in an approximately round (pipe) profile. The material formed in extruder 116 may be referred to as “extrudate.” Adapter 121 on the end of extruder 116, in general, has a different cross section resulting in a difference in velocity profile across the cross section of the extrudate perpendicular to the flow of the extruded material. The extrudate flows at different rates across the cross section to fill the new cross section of adapter 121 resulting in a different residence time for portions of the extrudate before exiting adapter 121 due to different flow path lengths. When the unsteady state extruder throat feed is coupled with the residence time differences before exiting adapter 121, a non-uniform coloring of the extruded material in both the cross sectional direction and in the extrusion direction results. The length and diameter of internal cavity 303 of extruder 116 are selected to avoid complete longitudinal mixing of the materials in extruder 116.

With reference to FIG. 4, an exemplary process for forming a product 124 is shown. Extruded material 122 exits extruder 116 through adapter 121 that gives the exiting, extruded material a cross-sectional shape. For example, the cross-sectional shape may be circular or rectangular. Extruded material 122 for example is placed in die 400 that extrudes a shaped material 408 or product 124 having a different cross section. The cross section may be any shape as known to those skilled in the art both now and in the future. Die 400 may include a cutting system for cutting the shaped material 408 or product 124 into lengths. Die 400 may directly connect with extruder 116 or be separate from extruder 116 with a conveyor belt transferring extruded material 122 to die 400.

Shaped material 408 may be placed manually or robotically into a conveyor oven 402 to further melt shaped material 408. Heated material 410 from conveyor oven 402 may be placed manually or robotically into a press 404 to compress heated material 410 into a molded shape 412. Once the mold is closed by the press, the composite material may be cooled long enough to form a cooled skin on product 124 so that product 124 can be transported outside press 404 either robotically or manually possibly for further cooling and/or drying. In an exemplary embodiment, extruding of heated material 410 is perpendicular to a grain of product 124. When press 404 is closed to compress heated material 410, flow of the heated material 410 occurs in the grain direction of product 124 resulting in streaks in the grain direction that are varied across product 124 to give a two dimensional variation in coloring. Product 124 can have any shape, size, or texture as required to form the desired building product.

Process 100 may be done in a continuous fashion with materials continuously fed into feeder 114 and a conveyor system of molds that are sequentially filled from extrusion process 106. The molding process may also be intermittent with each mold being filled and the each portion of the process stopped before process 100 starts again. A semi-continuous process fall somewhere in between.

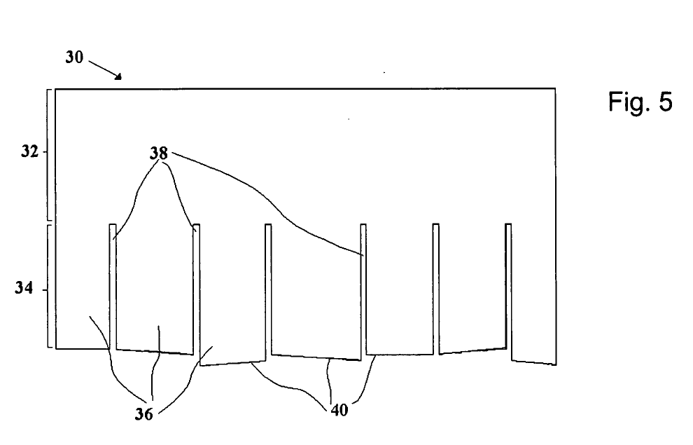

With reference to FIG. 5, an exemplary product 124 is shown. Product 124 comprises a shingle 30 having an upper portion 32, or head lap, and a lower portion 34 integrally formed with upper portion 32. Lower portion 34 includes a plurality of vertically extending tabs 36 separated by gaps 38. Tabs 36 extend from upper portion 32 and include edges 40 opposite upper portion 32. Tabs 36 may be of similar size and shape or of irregular size and shape as required to simulate a “natural” building material such as clay, ceramic, slate, stone, brick, wood, etc. The portion of shingle 30 to be viewed preferably is textured to provide shingle 30 with the look and/or feel of the “natural” building material. This is particularly preferable when shingle 30 is used in the interior of a building or as exterior siding. Upper portion 32 can be patterned with a variety of indentations and ridges to stiffen and/or reduce the weight of shingle 30. When viewed in cross-section, the thickness of shingle 30 can taper in various ways from edges 40 to upper portion 32. Alternatively, the thickness of shingle 30 can be uniform or exhibit other variation in thickness.

In an alternate embodiment, product formation process 106 may include injection of the extrudate into a mold and curing of the extrudate in the desired shape of the object as known to those skilled in the art. The extrudate is injected into a die of the mold through a nozzle disposed on extruder 116 instead of adapter 121. The die comprises a mold cavity and core portions that define the shape of product 124. The mold cavity and its associated core portions are pressurized for a period of time to “set” the extrudate, thereby allowing the finished object to maintain its shape once the extrudate is cooled. In order to produce an object that will not deform upon its removal from the mold, the mold may be cooled. In another alternative embodiment, product formation process 106 may include coating of the extrudate onto a substrate of material as known to those skilled in the art.

In another alternate embodiment, coextrusion of multiple materials may be used to form the product. For example, different extruders may apply different colors of material into the die resulting in a cross section having different color bands. The extruders may be joined to mix material in a section of a “main” extruder so that the colors are not fully mixed. For example, the extruders may meet in the last flight or two of the “main” extruder resulting in a swirl or two of the different color(s). Again, the differences in flow path length in the die give rise to variation particularly if followed by compression molding even if the colors enter the die adaptor together.

The foregoing description of exemplary embodiments of the invention have been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A process for forming a composite product having a color variation representative of a natural building material, the process comprising:
providing a first amount of a first material to an extruder, the first material comprising a first fiber, a first resin, and a first colorant;
providing a second amount of a second material to the extruder, the second material comprising a second fiber, a second resin, and a second colorant, wherein the second colorant is different than the first colorant;
mixing at least a portion of the first amount with at least a portion of the second amount in the extruder to form a third material;
extruding the third material from the extruder; and
forming a product from the extruded third material;
wherein the formed product has a color variation representative of a natural building material.

2. The process of claim 1, wherein the formed product is selected from the group consisting of a roofing tile, a roofing shingle, a roofing shake, a flooring tile, a flooring board, a siding board, a paneling board, a decking post, a decking board, a decking rail, a fence post, a fence board, and a fence rail.

3. The process of claim 1, wherein the natural building material is selected from the group consisting of ceramic, clay, wood, slate, stone, brick, concrete, metal, and combinations thereof.

4. The process of claim 1, wherein the first amount of the first material and the second amount of the second material are substantially equal.

5. The process of claim 1, wherein the first fiber is a natural plant fiber selected from the group consisting of barley, wheat straw, rice straw, rice hulls, soy stalks, stalks of perennial grasses, stalks of annual grasses, sugar cane bagasse, kenaf, sawdust, wood, wood flour, hemp, coconut coir, jute, sisal, flax, coir pith, cotton, other forest product residue, and mixtures thereof.

6. The process of claim 1, wherein the first resin is a synthetic polymeric material selected from the group consisting of polyolefin, a thermoplastic polymer, and combinations thereof.

7. The process of claim 1, wherein the first resin is the same as the second resin.

8. The process of claim 1, wherein the first fiber is the same as the second fiber.

9. The process of claim 1, wherein the first resin is different from the second resin.

10. The process of claim 1, wherein the first fiber is different from the second fiber.

11. The process of claim 1, further comprising:
feeding a third amount of a third material to the extruder, the third material comprising a third fiber, a third resin, and a third colorant; wherein the third colorant is different than the second colorant; and
mixing at least a portion of the third amount with at least a portion of the second amount in the extruder to form the third material.

12. The process of claim 11, wherein the third colorant is different than the first colorant.

13. The process of claim 1, further comprising compounding the first fiber, the first resin, and the first colorant to form the first material.

14. The process of claim 1, wherein forming the product from the extruded third material is a process selected from the group consisting of a linear extrusion process, a compression molding process, and an injection molding process.

15. The process of claim 1, wherein forming the product from the extruded third material comprises extruding the third material through a die.

16. The process of claim 1, wherein forming the product from the extruded third material comprises coating the third material on a substrate.

17. The process of claim 1, further comprising selecting the first colorant and the second colorant based on a color analysis of the natural building material.

18. The process of claim 1, further comprising selecting the first amount of the first material and the second amount of the second material based on a color analysis of the natural building material.

19. The process of claim 1, further comprising selecting the first amount of the first material using a random number selected using a statistical distribution.

20. The process of claim 1, wherein forming the product from the extruded third material uses a compression molding process, wherein the compression molding process comprises:
dispensing the extruded third material from the extruder into a mold in a first direction; and
closing the mold with pressure to force the extruded third material substantially in a second direction to fill the mold.

21. The process of claim 20, wherein the first direction and the second direction are substantially perpendicular to each other.

22. The process of claim 1, wherein forming the product from the extruded third material uses an injection molding process, wherein the injection molding process comprises injecting the extruded third material into a mold.

23. A system for forming a composite product having a color variation representative of a natural building material, the system comprising:
a feeder, wherein the feeder provides a first amount of a first material and a second amount of a second material to an extruder, the first material comprising a first fiber, a first resin, and a first colorant, the second material comprising a second fiber, a second resin, and a second colorant, wherein the second colorant is different than the first colorant;
the extruder, wherein the extruder mixes at least a portion of the first amount with at least a portion of the second amount to form a third material; and
a die operably connected with the extruder to extrude the third material thereby forming a product from the extruded third material;
wherein the formed product has a color variation representative of a natural building material.
